(19) United States
(12) Patent Application Publication
(10) Pub. No.: US 2004/0176114 A1
(43) Pub. Date: Sep. 9, 2004

(54) MULTIMEDIA AND TEXT MESSAGING WITH SPEECH-TO-TEXT ASSISTANCE

(76) Inventor: John W. Northcutt, Chapel Hill, NC (US)

Correspondence Address: MOORE & VAN ALLEN, PLLC, 2200 W MAIN STREET, SUITE 800, DURHAM, NC, 27705, US

(21) Appl. No.: 10/248,982

(22) Filed: Mar. 6, 2003

(51) Int. Cl. H04Q 7/20

(52) U.S. Cl. 455/466; 455/563

(57) ABSTRACT

A system and method of creating a multi-media voice and text message on a mobile phone where the voice portion of the MMS message is a verbatim rendition of the text portion or a personalized description of the text portion. The mobile phone includes a messaging function responsive to voice and text input. The message composer accesses the mobile phone's messaging function and speaks a message. The spoken message is recorded converted to a text message. If the message is personalized, the message composer records a second spoken message contextually related to the text message. Now, the text portion and the second spoken message are combined into an MMS message and sent to a recipient using the mobile phone's messaging functions. There is also disclosed a system and method of creating an MMS message on a mobile phone utilizing canned messages and speech-to-text assistance to edit the canned message. The message composer accesses the mobile phone's messaging function and inputs part of a message, either by voice or text. The mobile phone compares the input to a database and displays a list of text messages that closely match the input. The message composer selects one of the displayed text messages. This message is then featured in a text editing function so that it may be completed.

### BACKGROUND OF INVENTION

One of the most used features of mobile phones is messaging, either Short Messaging Service (SMS) text messaging or Multi-media Messaging Service (MMS) messaging. Subscribers often use these services in lieu of placing a call to another party. In addition, MMS provides the capability to include audible and visual attachments with a message.

Messaging is desirable because it does not interrupt the other party the way a phone call would. A receiving party can discreetly receive a message while in a meeting without causing a disturbance to others in the meeting.

The biggest drawback to using SMS or MMS messaging over a mobile phone is that inputting the message can be difficult due to the relatively small size of a mobile phone keypad. Moreover, a numeric keypad provides a clumsy means for inputting text. Keyboard accessories that facilitate text entry are available for mobile phones but they too are quite small and difficult to manage effectively.

What is needed is a system or method for simplifying creation and sending of SMS or MMS messages to another party.

### SUMMARY OF INVENTION

Mobile phone manufactures often include “canned” messages in the phone's memory. These canned messages are ones that are repeated often. The user merely scrolls through a list of canned messages and selects one to send. The act of scrolling through and selecting a canned message is presumably less time consuming than editing the same message from scratch. Users can also append to the list of canned messages with their own creations.

A canned message works well at providing a starting point for a message but cannot always provide the specifics of a message. For instance, a canned message could be “Meet me ______ at ______ where the first blank could specify a time (e.g., today, tonight, tomorrow) while the second blank could specify a place (e.g., home, work, school). Obviously, a single canned message cannot cover all the permutations of a desired message. It is also impractical to create a canned message for each permutation. The most efficient solution is to use a generic canned message that can be edited to suit the user's instant needs.

Editing a canned message, however, presents the same mobile phone data entry issues as described earlier. One solution is to incorporate speech-to-text processing to assist in the editing of SMS and MMS messages.

One embodiment of the present invention describes a system and method of creating a multi-media voice and text message on a mobile phone where the voice portion of the MMS message is a verbatim rendition of the text portion. The mobile phone includes a messaging function responsive to voice and text input. The message composer accesses the mobile phone's messaging function and speaks a message. The spoken message is recorded converted to a text message. Finally, the text portion and spoken portion are combined into an MMS message and sent to a recipient using the mobile phone's messaging functions.

Another embodiment of the present invention describes a system and method of creating a multi-media voice and text message on a mobile phone where the voice portion and the text portion of the MMS message are different. This allows the message composer to personalize either the text portion or the voice portion. The message composer accesses the mobile phone's messaging function and speaks a message. The spoken message is recorded converted to a text message. At this point, the message composer records a second spoken message contextually related to the text message. Now, the text portion and the second spoken message are combined into an MMS message and sent to a recipient using the mobile phone's messaging functions.

Yet another embodiment of the present invention describes a system and method of creating an MMS message on a mobile phone utilizing canned messages and speech-to-text assistance to edit the canned message. The message composer accesses the mobile phone's messaging function and inputs part of a message, either by voice or text. The mobile phone compares the input to a database and displays a list of text messages that closely match the input. The text messages contain at least one open field to be filled in with specific information to make the message complete. The message composer selects one of the displayed text messages. This message is then featured in a text editing function so that it may be completed.

Editing the selected text message is achieved with speech to text assistance. A voice input is received for the first/next open field in the selected text message. The voice input is converted to a text input. The text input is compared to a database to try to find a match.

If there is a match, then it is determined if the match corresponds to a word (phrase), an image, or both. If the match is a word (phrase), then the open field is filled with the word (phrase). If the match is an image, then the open field is filled with the image. If the match corresponds to both a word (phrase) or an image, then the message composer selects either the word (phrase) or the image and fills the open field with the selection. A check is made to see if there are more open fields in the canned message. If there are more open fields, then control is returned to the voice input step and the process is repeated. Otherwise, the editing process is terminated.

If there is not match, then the mobile phone displays the closest match in the database and asks the message composer whether to use the closest match.

If the closest match is used, then the open field is filled with the closest match. A check is made to see if there are more open fields in the canned message. If there are more open fields, then control is returned to the voice input step and the process is repeated. Otherwise, the editing process is terminated.

If the closest match is not used, then the mobile phone prompts the message composer to add the current text input to the database. The current input is placed into the open field. A check is made to see if there are more open fields in the canned message. If there are more open fields, then control is returned to the voice input step and the process is repeated. Otherwise, the editing process is terminated.

### BRIEF DESCRIPTION OF DRAWINGS

FIG. 1 is a flowchart describing the creating and sending of SMS or MMS messages from canned messages.

FIG. 2 is a flowchart describing the process of editing a canned message using voice and/or predictive text input.

FIG. 3 is a flowchart describing the creating and sending of SMS or MMS messages with speech-to-text assistance.

### DETAILED DESCRIPTION

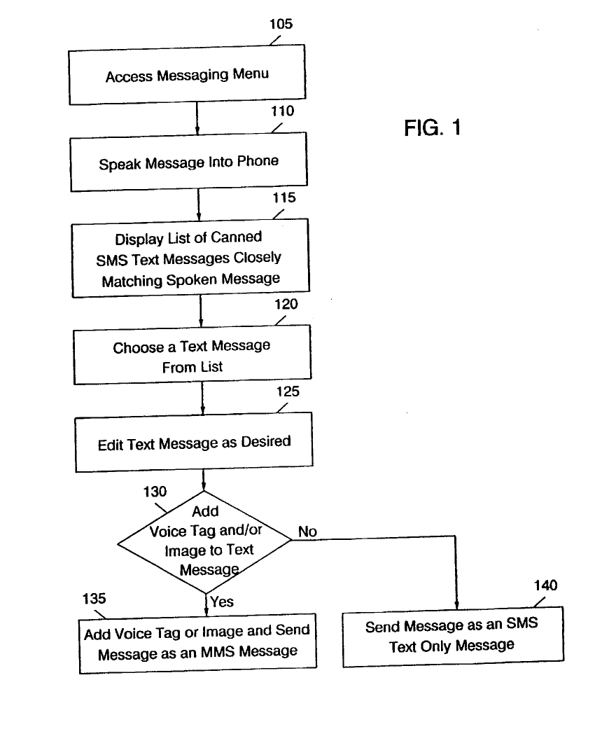

FIG. 1 is a flowchart describing the creating and sending of SMS or MMS messages from canned messages. A user (message composer) accesses the mobile phone's messaging function 105. This is typically done by navigating a graphical user interface (GUI) menu structure programmed into the mobile phone. Alternatively, the mobile phone can be programmed to respond to voice input to activate the messaging function. The message composer then speaks a message 110 into the mobile phone's microphone causing the mobile phone's screen to display a list 115 of canned messages that most closely match the spoken message.

This is achieved by first converting the spoken message to text and comparing it against a database of canned text messages. Alternatively, the spoken message can be compared against a database of spoken “canned” messages that are associated with text interpretations. Either way, the result is a displayed list of text messages that closely match the message composer”s spoken message.

The user then selects 120 from among the listed canned messages. This message is then featured alone on the screen where it can be edited 125. Once editing is complete, the message composer is prompted to add a voice tag or an image 130 to the text message. If neither a voice tag nor image is added to the message then the message is sent to a recipient as an SMS message 135 (text only). Otherwise, the text and voice and/or image is made into an MMS message and sent using the MMS functionality 140 of the mobile phone.

Steps 110(Speak Message into Phone) and 115 (Display List of Canned Messages . . . ) require speech-to-text processing. This speech-to-text processing is achieved by a digital signal processor (DSP) within the mobile phone. The DSP is operably coupled with the mobile phone's microphone, screen display, as well as a database of canned messages that can be either text-based, sound-based, or both. The DSP can be simplified by limiting its processing to words or phrases as opposed to sounds or phonemes. This is a less robust implementation but it is also a much less taxing system with respect to processing requirements including power consumption. However, a more complex DSP can be implemented that provides greater speech-to-text processing capabilities.

As earlier stated, the most efficient compromise for creating and sending SMS or MMS messages is to utilize “canned” message templates as a starting point. These messages need to be completed by filling in blank fields with specific data. These fields can be filled in via text entry or voice entry. Voice entry uses the aforementioned speech-to-text processing capability.

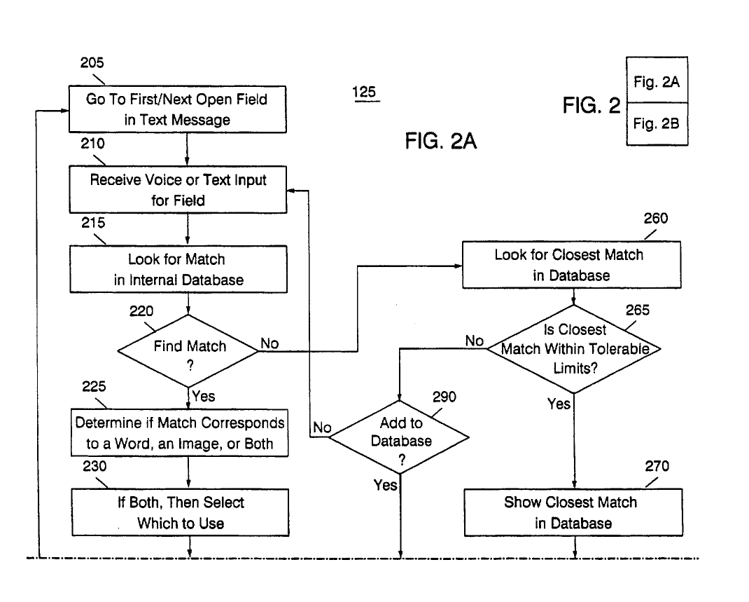

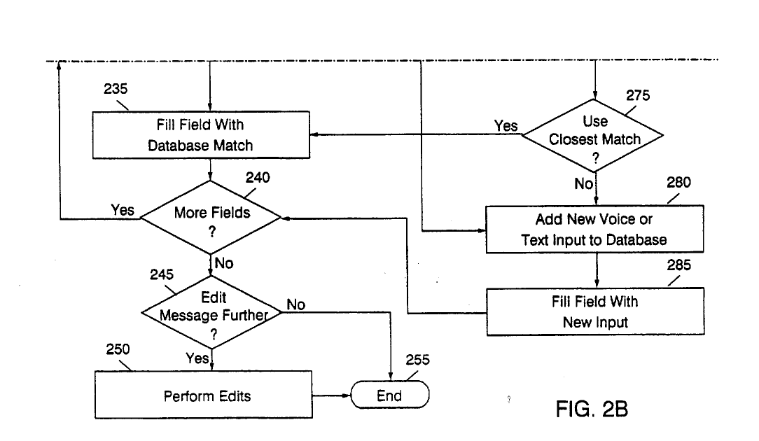

FIG. 2 is a flowchart describing the FIG. 1 step 125 process of editing a canned message using voice and/or predictive text input. Since the process for text and voice entry is very similar it will be described jointly with particular references to voice or text when appropriate. In addition, the process of editing the canned message can be a hybrid of text and/or voice input.

Once the canned message template has been selected (FIG. 1 step 120), it is brought into a text editor. This means that the canned message is displayed by the mobile phone such that it can be edited. The text editor will move a cursor to the first blank field 205 in the canned message and await either a voice or a text input 210. The voice or predictive text input is compared to a database of inputs 215, 220 in hopes of finding a match.

If the input is a voice input, then speech-to-text processing is utilized to convert the voice input to text for comparison against a text based database. Alternatively, the voice input can be compared to a sound based database. Each of the sounds (words or phrases) in the database is associated with a text representation of the word or phrase such that when a voice match is found a text response is returned. The database can also contain pointers to images. For instance the word “bird” can represent text or can represent an image of a bird.

If an exact match is found in the database, then it is determined whether the match refers to a word (or phrase), an image, or both 225. If both a word and an image correspond to the data input, then the message composer is prompted to choose 230 which to use for the current message. Upon making a selection, the choice is placed 235 into the canned message field. A check is made 240 to see if more blank fields are present in the current message. If so, control is sent back to step 205 so that the message composer can provide input the next open field in the canned message. If no more blank fields are present in the current message, a check is made to determine if the message composer wishes to edit the message further 245. If so, the message composer edits the message via text or voice entry 250 before terminating the editing process 255. If no additional message editing is desired, the editing process is terminated 255.

If a match cannot be found after performing steps 215, 220, then the database will look for the closest match in the database 260 and check to see if the closest match is within a tolerable limits 265. The database displays 270 all tolerable matches and the message composer is asked to select one of the closest matches 275. If one of the closest matches is selected then control is sent to step 235 and the blank field is filled with the selection. If the message composer rejects the closest matches, the input is added to the database 280. If the input was a voice input and there is a sound database, it is added to the sound database as recorded and a textual association is created. Voice inputs are also converted to text and added to the text database. The new input is then placed into the current blank field 285 as text and control is sent to step 240 for processing as described above.

If there are no matches within tolerable limits after performing step 265, then a further check is performed to see if the message composer wants to add the current input to the database 290. If so, control is sent to step 280 where the message composer is prompted to add the new input to the database and processing proceeds as described above. If the current input is unsatisfactory to the message composer and he does not want to enter it into the database, then control is returned to step 210 and a new voice or text input is received.

The database(s) may be separately manipulated by the user to add, delete, or modify existing entries. Pointers to images or sounds may also be created for database entries. In addition, if the message recipient is in the mobile phone's phonebook and happens to have an image tagged to the phonebook entry, the image can be made to pop-up upon voice entry of the recipient. This would provide a means of verifying that the mobile phone correctly interpreted the message composer's voice entry.

Earlier it was mentioned that speech-to-text functions could be simplified by limiting the vocabulary to a subset of words or phrases as opposed to sounds or phonemes. The net effect is to reduce the MIP, memory, and power requirements needed to implement speech-to-text processing. To achieve this goal the speech-to-text function could be limited to the canned message editor application. This would reduce the digital signal processor (DSP) search table (database) to a few canned phrases. The number of words that logically fit within the context of these phrases is also reduced. Similarly, the number of associated images and sounds is reduced. The reduction leads to a corresponding reduction in the required training of speech-to-text algorithms. Algorithm training can be performed during the manufacturing process (before the mobile phone reaches the end user). The training would recognize table (database) entries that are indexed by the canned message application. This reduces the number of MIPs required to carry out the application. Moreover, the speech-to-text algorithm need only be activated when the canned message application is active. This avoids having the power consuming process running in the background when not in use.

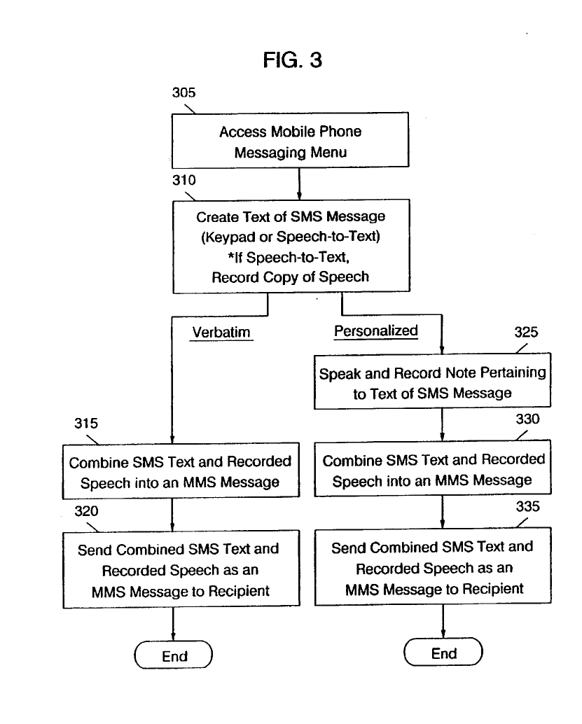

Another embodiment of the present invention is an implementation that does not use “canned” message templates. FIG. 3 is a flowchart describing the creating and sending of SMS or MMS messages with speech-to-text assistance. In this embodiment messages are created and a voice tag or image is combined with the text message to form an MMS message. The resulting MMS message is then sent to a recipient. The voice tag can be a verbatim representation of the text message giving the recipient the option of either reading or listening to the message. Or, the voice tag can be a personalized message that accompanies the text message.

The option of adding a voice tag or an image to a message greatly enhances the messaging utility. For instance, the standard text message could be accompanied by a voice tag that tells the recipient to listen and respond. An example of a personalized message would be an MMS message with a text component and a voice tag component where the voice tag could say, “John, read this and call me to discuss.” Alternatively, the voice tag could contain the content (like an MP3 snippet) with a text component asking, “John, do you like this new song?” Similarly, an image can be sent in an MMS message with a text component inviting a response like, “John, what do you think of this picture?”

This process also begins by accessing the mobile phone's messaging function 305. The text message is created 310 using either keypad text entry or speech-to-text voice entry. If voice entry is the selected method, then the message composer's speech is recorded as well as converted to text.

If the message composer merely wishes to create a verbatim copy of the text message, then the text message and voice recording are combined 315 into an MMS message. The MMS message is then sent 320 to a recipient.

If the message composer wishes to personalize the text message, he speaks and records a note pertaining to the text message 325. The text message and personalized voice recording are combined 330 into an MMS message and sent 335 to a recipient.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

1. A method of creating a message on a mobile phone, the mobile phone including a messaging function responsive to voice and text input, the method comprising:
accessing the messaging function;
speaking a message using voice input;
recording the spoken message;
converting the spoken message to a text message; and
combining the text message and spoken message into an MMS message.

2. A method of creating a message on a mobile phone, the mobile phone including a messaging function responsive to voice and text input, the method comprising:
accessing the messaging function;
speaking a message using voice input;
converting the spoken message to a text message;
recording a second spoken message contextually related to the text message; and
combining the text message and the second spoken message into an MMS message.

3. A method of creating a message on a mobile phone, the mobile phone including a messaging function responsive to voice and text input, the method comprising:
accessing the messaging function;
inputting part of a message;
displaying a list of text messages that closely match the input wherein the text messages contain at least one open field;
selecting one of the displayed text messages; and
editing the selected text message.

4. The method of claim 3 wherein inputting part of a message is achieved using voice input.

5. The method of claim 4 further comprising converting the voice input to text.

6. The method of claim 3 wherein inputting part of a message is achieved using text input.

7. The method of claim 3 further comprising optionally adding a voice tag to the edited text message and combining the voice tag with the edited text message to form an MMS message.

8. The method of claim 3 further comprising optionally adding an image to the edited text message and combining the image with the edited text message to form an MMS message.

9. The method of claim 3 wherein editing the selected text message comprises:
(a) displaying the selected text message;
(b) receiving a voice input for an open field in the selected text message;
(c) converting the voice input to a text input;
(d) looking a match between the converted voice input and a database of text;
if there is a match, then
(e) determining if the match corresponds to a word, an image, or both;
if just a word or just an image, then
(f) filling the open field with the word or image;
if both, then
(g) selecting either the word or the image and filling the open field with the selection;
(h) checking for more open fields;
if there are more open fields, then
(i) returning to step (b), otherwise terminating the editing process,
if there is not a match, then
(j) finding the closest match in the database;
(k) prompting whether to use the closest match;
if using closest match, then
(l) filling the open field with the closest match;
(m) checking for more open fields and if there are more open fields, then returning to step (b), otherwise terminating the editing process,
if not using closest match, then
(o) prompting to add current text input to database;
(p) filling the open field with the current text input;
(q) checking for more open fields and if there are more open fields, then returning to step (b), otherwise terminating the editing process.

10. The method of claim 9 further comprising checking if the closest match found corresponds to the text input within tolerable limits.

11. The method of claim 10 wherein if the closest match found does not correspond to the text input within tolerable limits, prompting to add current text input to database.

12. The method of claim 9 further comprising editing the message further once all the open fields have been filled.

13. A system for creating a message on a mobile phone, the mobile phone including a messaging function responsive to voice and text input, the system comprising:
means for accessing the messaging function;
means for receiving a spoken message;
means for recording the spoken message;
means for converting the spoken message to a text message; and
means for combining the text message and spoken message into an MMS message.

14. A system for creating a message on a mobile phone, the mobile phone including a messaging function responsive to voice and text input, the system comprising:
means for accessing the messaging function;
means for receiving a spoken message;
means for converting the spoken message to a text message;
means for receiving and recording a second spoken message contextually related to the text message; and
means for combining the text message and the second spoken message into an MMS message.

15. A system for creating a message on a mobile phone, the mobile phone including a messaging function responsive to voice and text input, the system comprising:
means for accessing the messaging function;
means for inputting part of a message;
means for displaying a list of text messages that closely match the input wherein the text messages contain at least one open field;
means for selecting one of the displayed text messages; and
means for editing the selected text message.

16. The system of claim 15 wherein the means for inputting part of a message is a microphone that receives a voice input.

17. The system of claim 16 further comprising means for converting the voice input to text.

18. The system of claim 15 wherein the means for inputting part of a message is a keypad for text input.

19. The system of claim 115 further comprising means for adding a voice tag to the edited text message and means for combining the voice tag with the edited text message to form an MMS message.

20. The system of claim 15 further comprising means for adding an image to the edited text message and means for combining the image with the edited text message to form an MMS message.

21. The method of claim 15 wherein the means for editing the selected text message comprises:
means for displaying the selected text message;
means for receiving a voice input for an open field in the selected text message;
means for converting the voice input to a text input;
means for looking a match between the converted voice to text input and a database;
means for determining if a match corresponds to a word, an image, or both in the database;
means for selecting either a word or an image from the database;
means for filling the open field with a word or image;
means for finding a closest match in the database to the converted voice to text input;
means for prompting whether to use the closest match;
means for filling the open field with the closest match;
means for adding the converted voice to text input to the database;
means for filling the open field with the converted voice to text input;
means for checking for more open fields in the selected text;
means for returning control to the means for receiving a voice input for an open field in the selected text message; and
means for terminating the editing process.

22. The system of claim 21 further comprising means for checking if the closest match found corresponds to the text input within tolerable limits.

23. The system of claim 22 further comprising means for prompting to add current text input to database if the closest match found does not correspond to the text input within tolerable limits.

24. The method of claim 21 further comprising means for editing the message further once all the open fields have been filled.
